(19) United States
(12) Patent Application Publication
(10) Pub. No.: US 2014/0229265 A1
(43) Pub. Date: Aug. 14, 2014

(54) METHOD FOR ENHANCING CONTRACT BASED MOBILE PHONE CONSUMER EXPERIENCE

(71) Applicants: Adam Epner, New york, NY (US); Eliyahou Setton, New York, NY (US); Meyer Cohen, Boca Raton, FL (US)

(72) Inventors: Adam Epner, New york, NY (US); Eliyahou Setton, New York, NY (US); Meyer Cohen, Boca Raton, FL (US)

(21) Appl. No.: 14/164,221

(22) Filed: Jan. 26, 2014

(51) Int. Cl. G06Q 30/02

(52) U.S. Cl. CPC G06Q 30/0235
USPC 705/14.35

(57) ABSTRACT

The various embodiments herein provide a method for enhancing a wireless customer's experience by providing incentives in exchange for the consumer signing a limited period contract. The method comprises the steps of offering a new mobile phone for a subsidized price to an existing consumer, providing an additional discount on the new mobile phone in order to renew the contract at the contract commencement, providing an option for retaining their existing mobile phone that they are already accustomed and continue using the service without signing a renewal, allowing the existing consumer to choose a third party service provider for contract renewal, allowing the third party service provider for purchasing the new mobile phone from the primary wireless service provider at the subsidized price on behalf of consumer, and receiving a monetary payment from the third party service provider in exchange of contract renewal.

### PRIORITY APPLICATION

This application claims priority to U.S. provisional application 61/876,881 filed on Sep. 12, 2013 and entitled “Method for upgrading cell phone contracts” which is hereby incorporated by reference.

### BACKGROUND

1. Technical field

The embodiments herein generally relate to a mobile communication network and particularly relate to mobile communication network service providers. The embodiments herein more particularly relate to a system and method for enhancing, maintaining and renewing a wireless service customer base by offering incentives to the mobile users for reviving and renewing a service contract and for enhancing a wireless consumer's experience.

2. Description of the Related Art

Wireless service providers have revolutionized the communication arena by allowing the consumers to purchase the higher end devices at a low cost/no cost basis. The value placed on a consumer willing to enter into a long-term contract with the cellular provider has proven to be a success for the major service providers.

Various methodologies have been proposed to enhance a wireless customer's experience, when the customer is eligible for upgrading a cell phone at the end of his/her contract tenure. The standard business process in the wireless industry is that a customer is eligible at the commencement of the two-year contract with the same service provider for a discounted phone, which is subsidized by the wireless service provider in exchange for an agreement to maintain the service with the provider for another two-year term.

The wireless service providers offer their customers with a cell phone at a discount when they sign the original contract, and then an additional discount on a new cell phone in order to renew the contract during the renewal or the commencement of the next contract. Many customers would prefer to retain their existing phones or simply cannot afford to buy a new phone even at the discounted price. The conventional methodologies do not allow the customer to enjoy the latest or new services offered by the service providers using their existing phone as they are already accustomed to or simply prefer the existing mobile phones and services. The service providers do not allow to the existing customers to continue the same wireless service without signing a renewal contract.

Hence there is a need for a system and method for enhancing an experience of the wireless customers by providing incentives in exchange for the renewal of the service contract. There is also a need for an improved method and system for enhancing a profitability of the wireless service providers and retaining consumer in a contract based wireless communication service.

The above-mentioned shortcomings, disadvantages and problems are addressed herein and which will be understood by reading and studying the following specification.

### OBJECTS OF THE EMBODIMENTS

The primary object of the embodiments herein is to provide a method for enhancing a wireless customer experience by providing incentives to the consumers in exchange for signing a limited period contract.

Another object of the embodiments herein is to provide a method for enhancing a profitability of wireless service provider and retaining consumer in a contract based wireless communication service.

Yet another object of the embodiments herein is to provide a method to retain the existing customers at a discounted rate.

Yet another object of the embodiments herein is to provide a method for allowing a third party service provider for purchasing new mobile phone from the primary wireless service provider at the subsidized price on behalf of a consumer.

Yet another object of the embodiments herein is to provide a method for generating and sending alerts to the consumers when contract is about to expire.

Yet another object of the embodiments herein is to provide a method to enable an authorized agent of the wireless service providers to buy new mobile phone from the primary wireless service provider at the subsidized price on behalf of a consumer and to sell the mobile phones to the whole sale dealers at a rate below a whole sale price thereby selling a significant quantity of mobile devices and increasing a profit.

Yet another object of the embodiments herein is to provide a method to diversify the purchase of mobile phones based on a market trend or a current demand in the wholesale market thereby reducing an upfront cost.

Yet another object of the embodiments herein is to provide a method to buy the mobile phones at a reduced price from the wireless service providers in exchange of a contract upgrade and to sell the latest and the hottest mobile phones through an online sales channel thereby increasing the profit for both the online sales channel and the authorized agents.

These and other objects and advantages of the present disclosure will become readily apparent from the following detailed description taken in conjunction with the accompanying drawings.

### SUMMARY

The various embodiments herein provide a method for enhancing a wireless customer experience by providing incentives to the existing customers/consumers in exchange for signing a limited period contract. The method for enhancing a contract based mobile phone consumer experience comprises the steps of determining consumers of the wireless communication service with a expired contract or expiring contract by a primary wireless service provider, notifying the consumers about the due date for a contract renewal by the primary wireless service provider, offering a new mobile phone at a subsidized price to an existing consumer on renewal of the existing contract by the primary wireless service provider, and wherein the primary wireless service provider offers the new mobile phone when the existing consumer signs an original contract, providing an additional discount on the new mobile phone for the existing consumer in order to renew the contract at the expiry of the contract; providing an option for the existing consumer to retain their existing mobile phone that they are already accustomed and continue using the primary wireless service provider's service without signing a renewal, allowing the existing consumer to choose a third party service provider for contract renewal, allowing the third party service provider for purchasing the new mobile phone from the primary wireless service provider at the subsidized price, and receiving a monetary payment from the third party service provider in exchange of a contract renewal by the existing consumer, and wherein the existing consumer continues to use his/her mobile phone for the duration of the term of the newly agreed signed contract.

According to an embodiment herein, the primary wireless service provider is benefitted from the renewed contract and continued to enjoy a low customer turnover. The consumer receives a monetary benefit from the third party service provider for a renewal and the third party service provider receives a benefit of subsidized priced new mobile phone for renewing the contract of a consumer with a service provider.

According to an embodiment herein, the primary wireless service provider offers a new mobile phone at the subsidized price to the existing consumer in exchange for renewing an agreement to maintain a service contract with the primary wireless service provider for a limited period of time.

According to an embodiment herein, the third party service provider is allowed to resale the new mobile phone purchased at the subsidized price from the primary wireless service provider.

According to an embodiment herein, a method is provided for enhancing a profitability of a wireless service provider and retaining a consumer in a contract based wireless communication service. The method comprises the steps of determining the consumers of the wireless communication service with the expiring or expired contracts by the wireless service provider, notifying the consumers about the due date for a contract renewal by the wireless service provider, offering an incentive to the consumers in exchange of contract renewal for a limited period by the wireless service provider, and retaining a contract of the consumer for using wireless communication service for a limited period.

According to an embodiment herein, the incentive offered to the consumers by the wireless service provider is a monetary payment.

According to an embodiment herein, the incentive offered to the consumers by the wireless service provider is a subsidized new mobile phone.

According to an embodiment herein, the wireless service provider posts the consumer contract details in a website. Further, the wireless service provider allows the consumers to view their contracts and renewal them by providing the login details.

According to an embodiment herein, the wireless service provider alerts the consumers when contract is about to expire, and wherein the alerts comprises an email notification, SMS, etc.

The various embodiments herein provide a computer implemented method run on a processor or a computing device of the primary wireless service provider for enhancing contract based mobile phone consumer experience. The method for enhancing a contract based mobile phone consumer experience comprises the steps of determining consumers of the wireless communication service with a expired contract or expiring contract by a primary wireless service provider, notifying the consumers about the due date for a contract renewal by the primary wireless service provider, offering a new mobile phone at a subsidized price to an existing consumer on renewal of the existing contract by the primary wireless service provider, and wherein the primary wireless service provider offers the new mobile phone when the existing consumer signs an original contract, providing an additional discount on the new mobile phone for the existing consumer in order to renew the contract at the expiry of the contract; providing an option for the existing consumer to retain their existing mobile phone that they are already accustomed and continue using the primary wireless service provider's service without signing a renewal, allowing the existing consumer to choose a third party service provider for contract renewal, allowing the third party service provider for purchasing the new mobile phone from the primary wireless service provider at the subsidized price, and receiving a monetary payment from the third party service provider in exchange of a contract renewal by the existing consumer, and wherein the existing consumer continues to use his/her mobile phone for the duration of the term of the newly agreed signed contract.

According to an embodiment herein, a computer implemented method which run on a processor or a computing device of the primary wireless service provider is provided for enhancing a profitability of a wireless service provider and retaining a consumer in a contract based wireless communication service. The method comprises the steps of determining the consumers of the wireless communication service with the expiring or expired contracts by the wireless service provider, notifying the consumers about the due date for a contract renewal by the wireless service provider, offering an incentive to the consumers in exchange of contract renewal for a limited period by the wireless service provider, and retaining a contract of the consumer for using wireless communication service for a limited period.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a flowchart indicating a method for enhancing a contract based mobile phone consumer experience, according to an embodiment herein.

FIG. 2 illustrates a flowchart indicating a method for enhancing profitability of a wireless service provider and retaining a consumer in a contract based wireless communication service, according to an embodiment herein.

FIG. 3 illustrates system architecture for enhancing a contract based mobile phone consumer experience, according to an embodiment herein.

Although the specific features of the present invention are shown in some drawings and not in others. This is done for convenience only as each feature may be combined with any or all of the other features in accordance with the present invention.

### DETAILED DESCRIPTION OF THE EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a method for enhancing a wireless customer experience by providing incentives to the existing customers/consumers in exchange for signing a limited period contract. The method for enhancing a contract based mobile phone consumer experience comprises the steps of determining consumers of the wireless communication service with a expired contract or expiring contract by a primary wireless service provider, notifying the consumers about the due date for a contract renewal by the primary wireless service provider, offering a new mobile phone at a subsidized price to an existing consumer on renewal of the existing contract by the primary wireless service provider, and wherein the primary wireless service provider offers the new mobile phone when the existing consumer signs an original contract, providing an additional discount on the new mobile phone for the existing consumer in order to renew the contract at the expiry of the contract; providing an option for the existing consumer to retain their existing mobile phone that they are already accustomed and continue using the primary wireless service provider's service without signing a renewal, allowing the existing consumer to choose a third party service provider for contract renewal, allowing the third party service provider for purchasing the new mobile phone from the primary wireless service provider at the subsidized price, and receiving a monetary payment from the third party service provider in exchange of a contract renewal by the existing consumer, and wherein the existing consumer continues to use his/her mobile phone for the duration of the term of the newly agreed signed contract.

According to an embodiment herein, the primary wireless service provider is benefitted from the renewed contract and continued to enjoy a low customer turnover. The consumer receives a monetary benefit from the third party service provider for a renewal and the third party service provider receives a benefit of subsidized priced new mobile phone for renewing the contract of a consumer with a service provider.

According to an embodiment herein, the primary wireless service provider offers a new mobile phone at the subsidized price to the existing consumer in exchange for renewing an agreement to maintain a service contract with the primary wireless service provider for a limited period of time.

According to an embodiment herein, the third party service provider is allowed to resale the new mobile phone purchased at the subsidized price from the primary wireless service provider.

According to an embodiment herein, a method is provided for enhancing a profitability of a wireless service provider and retaining a consumer in a contract based wireless communication service. The method comprises the steps of determining the consumers of the wireless communication service with the expiring or expired contracts by the wireless service provider, notifying the consumers about the due date for a contract renewal by the wireless service provider, offering an incentive to the consumers in exchange of contract renewal for a limited period by the wireless service provider, and retaining a contract of the consumer for using wireless communication service for a limited period.

According to an embodiment herein, the incentive offered to the consumers by the wireless service provider is a monetary payment.

According to an embodiment herein, the incentive offered to the consumers by the wireless service provider is a subsidized new mobile phone.

According to an embodiment herein, the wireless service provider posts the consumer contract details in a website. Further, the wireless service provider allows the consumers to view their contracts and renewal them by providing the login details.

According to an embodiment herein, the wireless service provider alerts the consumers when contract is about to expire, and wherein the alerts comprises an email notification, SMS, etc.

According to one embodiment herein, a computer implemented method that is run on a processor or a computing device of a primary wireless service provider is provided for enhancing a wireless customer experience by providing incentives to the existing customers/consumers in exchange for signing a limited period contract. The method for enhancing a contract based mobile phone consumer experience comprises the steps of determining consumers of the wireless communication service with a expired contract or expiring contract by a primary wireless service provider, notifying the consumers about the due date for a contract renewal by the primary wireless service provider, offering a new mobile phone at a subsidized price to an existing consumer on renewal of the existing contract by the primary wireless service provider, and wherein the primary wireless service provider offers the new mobile phone when the existing consumer signs an original contract, providing an additional discount on the new mobile phone for the existing consumer in order to renew the contract at the expiry of the contract; providing an option for the existing consumer to retain their existing mobile phone that they are already accustomed and continue using the primary wireless service provider's service without signing a renewal, allowing the existing consumer to choose a third party service provider for contract renewal, allowing the third party service provider for purchasing the new mobile phone from the primary wireless service provider at the subsidized price, and receiving a monetary payment from the third party service provider in exchange of a contract renewal by the existing consumer, and wherein the existing consumer continues to use his/her mobile phone for the duration of the term of the newly agreed signed contract.

According to an embodiment herein, the primary wireless service provider is benefitted from the renewed contract and continued to enjoy a low customer turnover. The consumer receives a monetary benefit from the third party service provider for a renewal and the third party service provider receives a benefit of subsidized priced new mobile phone for renewing the contract of a consumer with a service provider.

According to an embodiment herein, the primary wireless service provider offers a new mobile phone at the subsidized price to the existing consumer in exchange for renewing an agreement to maintain a service contract with the primary wireless service provider for a limited period of time.

According to an embodiment herein, the third party service provider is allowed to resale the new mobile phone purchased at the subsidized price from the primary wireless service provider.

According to an embodiment herein, a computer implemented method that run on a processor or a computing device of the primary wireless service provider is provided for enhancing a profitability of a wireless service provider and retaining a consumer in a contract based wireless communication service. The method comprises the steps of determining the consumers of the wireless communication service with the expiring or expired contracts by the wireless service provider, notifying the consumers about the due date for a contract renewal by the wireless service provider, offering an incentive to the consumers in exchange of contract renewal for a limited period by the wireless service provider, and retaining a contract of the consumer for using wireless communication service for a limited period.

According to an embodiment herein, the incentive offered to the consumers by the wireless service provider is a monetary payment.

According to an embodiment herein, the incentive offered to the consumers by the wireless service provider is a subsidized new mobile phone.

According to an embodiment herein, the wireless service provider posts the consumer contract details in a website. Further, the wireless service provider allows the consumers to view their contracts and renewal them by providing the login details.

According to an embodiment herein, the wireless service provider alerts the consumers when contract is about to expire, and wherein the alerts comprises an email notification, SMS, etc.

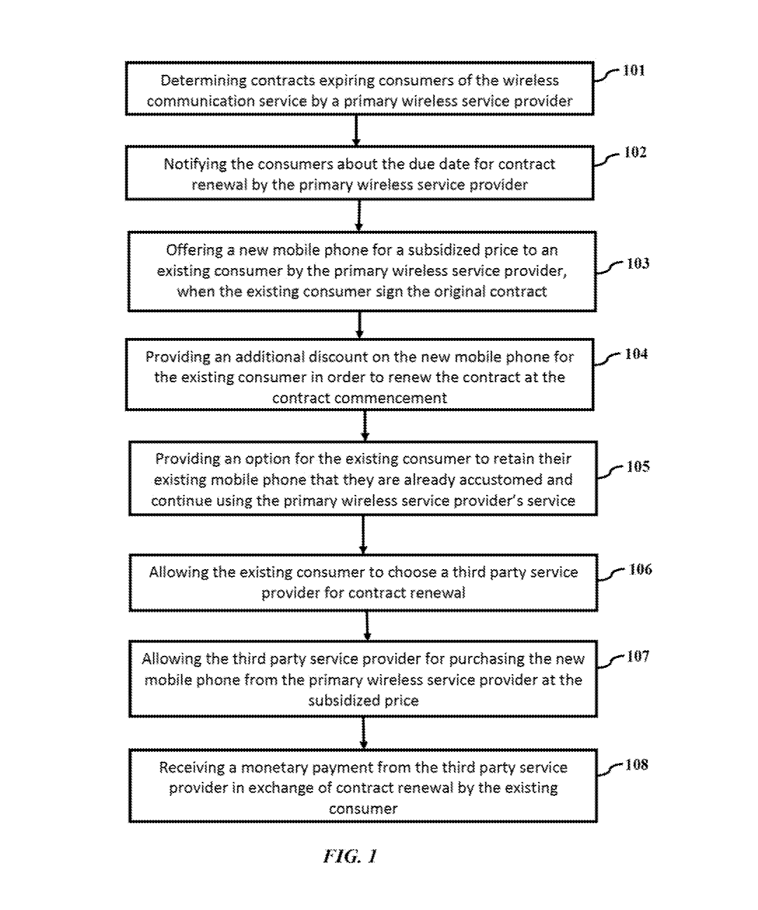

FIG. 1 illustrates a flowchart explaining a method for enhancing contract based mobile phone consumer experience, according to an embodiment herein. With respect to FIG. 1, a method is provided for enhancing an experience of a wireless customer by providing incentives to the consumer for a limited period in exchange for signing a contract. The method comprises the steps of determining consumers of the wireless communication service with expired/expiring contracts by a primary wireless service provider (101). The consumers are notified of the due date for contract renewal by the primary wireless service provider (102). A new mobile phone is offered for a subsidized price to an existing consumer by the primary wireless service provider. The primary wireless service provider offers the new mobile phone when the existing consumer signs the original contract (103). An additional discount is provided for the existing consumer on the new mobile phone in order to renew the contract at the expiry of the existing contract (104). An option is provided for the existing consumer to retain their existing mobile phone when they are already accustomed to and continue to use the existing service offered by the primary wireless service provider without signing a renewal contract (105). The existing consumer is allowed to choose a third party service provider for a contract renewal (106). The third party service provider is allowed for purchasing the new mobile phone from the primary wireless service provider at the subsidized price (107). A monetary payment is provided to the consumer from the third party service provider in exchange of renewing the existing contract (108). The existing consumer continues to use his/her mobile phone for the duration of the term of the newly agreed signed contract.

According to an embodiment herein, the primary wireless service provider benefits from the renewed contract and continues to enjoy the existing customer turnover without losing any customer base. The method enables the primary wireless service providers to increase the customer base by providing incentives or mobile phones at subsidized prices for renewing a contract or signing a new contract. The consumer receives a benefit of the monetary payment from the third party service provider for a contract renewal and the third party service provider receives a benefit of subsidized priced new mobile phone.

According to an embodiment herein, the primary wireless service provider offers new mobile phone at the subsidized price to the existing consumer in exchange for an agreement to maintain a service contract with the primary wireless service provider for a limited period of time.

According to an embodiment herein, the third party service provider is allowed to resale the new mobile phone purchased at the subsidized price from the primary wireless service provider.

Consider an example wherein a wireless service provider offers its consumer a cell phone for a discount when they sign the original contract, and then an additional discount on a new cell phone in order to renew the contract at the contract commencement. Many consumers would prefer to retain their existing mobile phones or simply cannot afford a new mobile phone even at the discounted price. If, for consumer with a contract that ends today is eligible for a new mobile phone at a price of $199.99. However, if the consumer would like to own that phone without a contract renewal, it would cost $599.99. The customer may enjoy using their existing phone that they are already accustomed to or simply prefer, and would continue using the same wireless service provider's service without signing a renewal. In some cases, the customer also may not be able to afford the $199.99 price to renew the contract despite the incentives of a lower cost. In this situation, the consumer chooses a third party service provider for contract renewal. The third party service provider purchases the new mobile phone from the primary wireless service provider at the subsidized price of $199.99 on behalf of the consumer. The third party service provider gives a monetary payment of $299.99 to the consumer, in exchange of contract renewal. The consumer continues to use his/her mobile phone (existing mobile phone) for the duration of the term of the newly agreed signed contract. Later the third party service provider resells the purchased new mobile phone with a comfortable profit of $399.99.

According to an embodiment herein, when a consumer's contract is over with the primary wireless service provider, the consumer is typically given an incentive to stay with the primary wireless service provider for an additional term. The consumers in general do not feel the need to switch to different wireless service providers when they are happy with their current service provider. Further, many customers will be happy with their current phone and will be willing to continue using the same device (mobile phone). Thus, in this situation, the consumers are offered monetary benefit (money) instead of the typical incentive (new phone at a deeply discounted price).

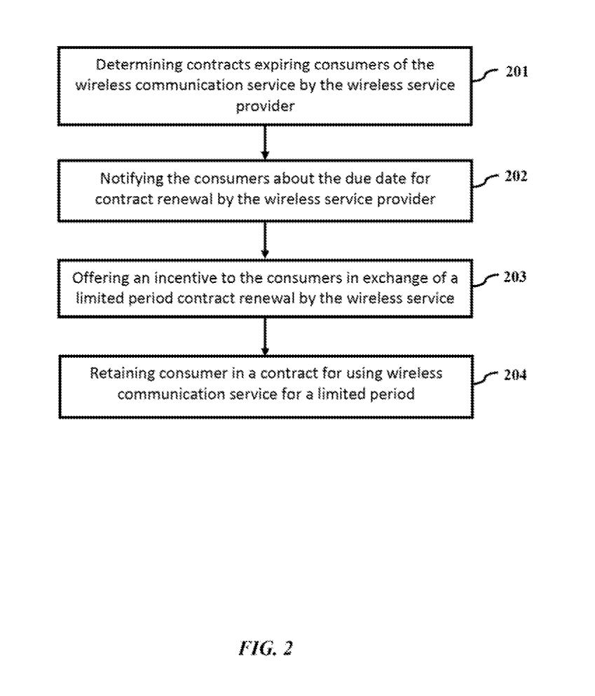

FIG. 2 illustrates a flowchart explaining a method is provided for enhancing a profitability of the wireless service provider and retaining consumer in a contract based wireless communication service, according to an embodiment herein. The method for enhancing wireless service provider profitability and retaining consumer in a contract based wireless communication service comprises the steps of determining the consumers of the wireless communication service with expired/expiring contracts by the wireless service provider (201). The consumers are notified of the due date for a contract renewal by the wireless service provider (202). An incentive is offered to the consumers for a limited period in exchange of a contract renewal by the wireless service provider (203). A service contract of the consumer is retained for using wireless communication service for a limited period (204).

According to an embodiment herein, the incentive offered to the consumers by the wireless service provider is a monetary payment.

According to an embodiment herein, the incentive offered to the consumers by the wireless service provider is a subsidized new mobile phone.

According to an embodiment herein, the wireless service provider posts the consumer's contract details in a website. Further, the wireless service provider allows consumers to view their contracts and renewal them by providing login details.

According to an embodiment herein, the wireless service provider alerts to the consumers when contract is about to expire, and wherein the alerts comprises an email notification, SMS, etc.

Consider a scenario wherein a wireless service provider customarily subsidizes the price of the new mobile phone in exchange for customer loyalty for a renewed two-year term. The wireless service provider sells the new mobile phone for $400 less to a customer who agrees to sign another two-year contract versus a customer willing to pay full price for the same phone without the requirement to renew the contract. In this scenario, the wireless service provider can offer the customer a sum significantly lower to retain the consumer. For example, if wireless service provider offers the customer $200 to retain their existing phone in exchange for a contract renewal, wireless service provider experiences a $400 savings for each consumer who agrees to receive a payment for his/her renewal. With the assumption that 50% of consumers are eligible for contract renewal incentives each year, even a small number of eligible consumers utilizing the above mentioned method could increase the profitability of the wireless service provider significantly. If even 1/10th of a percentage of consumers (i.e. 109,000 consumers) choose this option at renewal, the wireless service provider can easily increase the profitability by approximately $43 million.

The method disclosed in the embodiments herein provides an additional option for the wireless service providers to provide an incentive/ privilege offer to the consumers. The consumers are provided with a benefit of using the existing phone continuously, by simply signing an additional two-year contract agreement and receiving a compensation for that agreement. The consumers are satisfied because they receive a payment without changing anything about their plan (tariff) or mobile phone. The wireless service provider is satisfied because they retain the consumers without spending nearly the amount of money they would have spent by subsidizing the new mobile phone if the consumer chose that option.

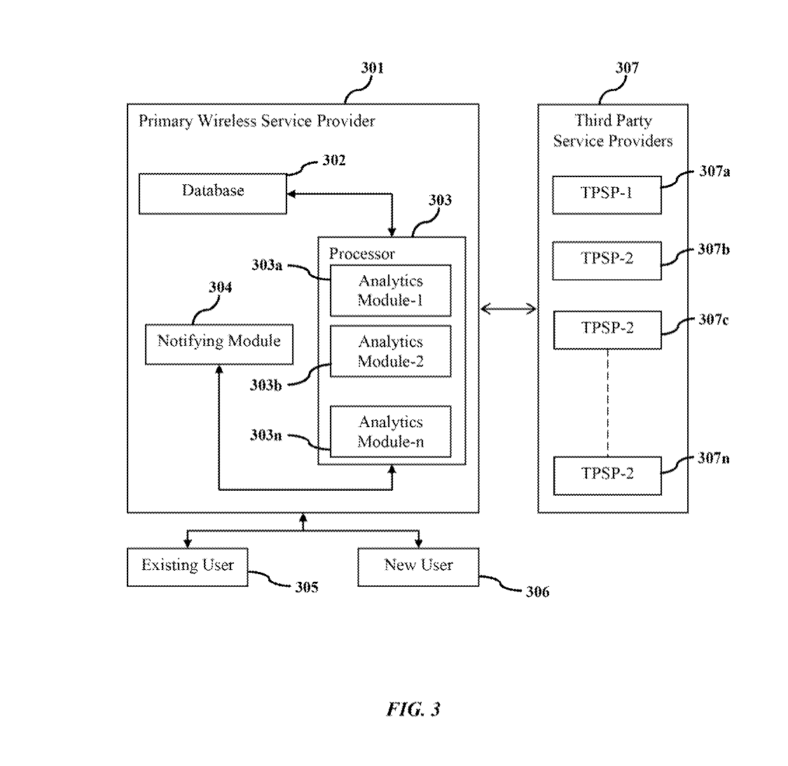

FIG. 3 illustrates system architecture for enhancing a contract based mobile phone consumer experience, according to an embodiment herein. With respect to FIG. 3, a system is provided for enhancing an experience of a wireless customer by providing incentives to the consumer for a limited period in exchange for signing a contract. The system comprises a primary wireless service provider 301 comprising a database 302 for storing existing consumers' 305 details comprising expired/expiring contracts, due date for contract renewal, demographic information, etc, a notifying module 304 for notifying existing consumers 305 with respect to expired/expiring contracts, due date for contract renewal, new deals, etc and a processor or a computing device 303 comprising a plurality of analytics modules (analytics module-1 303a, analytics module-2 303b and analytics module-n 303n) for determining consumers 305 with expired/expiring contracts, calculating a due date for a contract renewal, offering new deals such as offering new mobile communication device with a subsidized price, providing price discount for the existing consumer 305 to retain their existing mobile phone, offering new mobile communication device with a subsidized price for the new user 306 etc. The system further comprises one or more third party service provider 307 (TPSP-1 307a, TPSP-2 307b, TPSP-3 307c and TPSP-n 307n) for allowing the existing consumer 306 to choose at-least one third party service provider 307 for a contract renewal. The third party service provider 307 is allowed to purchase new mobile phone from the primary wireless service provider 301 at the subsidized price. A monetary payment is provided to the consumer 305 from the third party service provider 307 in exchange of renewing the existing contract. The existing consumer 305 continues to use his/her mobile phone for the duration of the term of the newly agreed signed contract.

According to an embodiment herein, the primary wireless service provider 301 benefits from the renewed contract and continues to enjoy the existing customer turnover without losing any customer base. The consumer 305 receives a benefit of the monetary payment from the third party service provider 307 for a contract renewal and the third party service provider 307 receives a benefit of subsidized priced new mobile phone.

According to an embodiment herein, the primary wireless service provider 301 offers new mobile phone at the subsidized price to the existing consumer 305 in exchange for an agreement to maintain a service contract with the primary wireless service provider 301 for a limited period of time.

According to an embodiment herein, the third party service provider 307 is allowed to resale the new mobile phone purchased at the subsidized price from the primary wireless service provider 301.

As evidenced above, the method enables the third party service providers or authorized agents to enter a contract with the primary wireless service providers to purchase the latest or hottest mobile phones from the wireless service providers for a price that is significantly less than wholesale value. According to a market analysis, the newest smart phones can be purchased for approximately $300, which includes a payment to the customer of $100 and a payment to the wireless service provider of $200 for the newest device. If the wholesale value at the launch of the new and hottest mobile phone such as IPhone-5 is approximately $580, the current price at which the Iphone-5 is purchased is significantly lower. By offering the devices to wholesalers such as online sales channel like Amazon.com, throughout the country at below wholesale prices, significant quantities of devices can be sold.

In addition, the devices purchased by the authorized agents can be diversified based on the current demand in the wholesale market. For example, if right now, the demand for iPhone's outweighs the demand for Samsung phones, and the buying patterns can be simply changed on the back-end without changing anything on the customer front-end. The devices even can be purchased from the wireless providers that offer certain models at no cost in exchange for the two-year commitment thereby reducing our up-front costs by 66%.

Finally, the newest trend being offered by the major wireless service providers are reduced cost tablet computers in exchange for a two-year commitment. This opens up yet another market for the third party service providers or authorized agents to purchase the latest electronic devices at a significantly lower cost than wholesale value. The diversified product base will ensure that the purchase of devices can be flipped at record speed with the right sales channels.

As competition among the major carriers increase, holding on to customers has proven to be difficult. The difficulty is increased with the growing trend of some prepaid and lower cost alternative providers that offer a cell phone financing plan whereby the consumer can purchase an expensive phone from the provider for a monthly fee that is added on to the customer's bill. Of course the fine print shows just how unattractive this option is. Customers who finance a phone from those providers are essentially locked into a contract because, the remaining balance on the lease becomes due immediately if they decide to leave the provider. In addition, interest charges apply to these financed phones unless the consumer has a high credit rating. Also, accidental damage is not covered under this plan, so when a customer accidentally breaks the device, the customer may opt to repair it for whatever cost, or continue paying the monthly fee with a non-functional device. This differs from a customer that purchased a subsidized phone in exchange for a two-year commitment in that the customer that purchased the subsidized phone for $200 and broke their phone will pay $200 plus the cost of a new device, while the customer that purchased a financed phone and then broke it will pay for the new phone and the cost of the broken phone over the 24 months.

The method provide significant synergies by exploiting with the on line sales channels or stores like Amazon.com that would be highly profitable for both the third party service providers and the on line sales stores.

According to one embodiment herein, a third part service provider can become an authorized agent with the a plurality of wireless service providers (such as Verizon Wireless, AT&T and Sprint) and be able to offer contract upgrades in exchange for the right to purchase our customer's phones. By becoming an authorized agent, the third party service provider can access the contract end dates, sign up customers and purchase the phones on behalf of these customers. The pros of becoming an agent are to access customer data and buy the upgrades from the customers directly. In addition, the third party service provider is able to capture the commission from the wireless service providers for each upgraded contract. The cons include having to hold on to merchandise until a customer signs up and the requirement to maintain quotas that the master dealers may impose for numbers of upgrades the third party service provider must perform per month.

To illustrate our point in the embodiments herein, the estimations included only customers subscribing to one particular primary wireless service providers, just to emphasize the magnitude of the profits achievable if only 1/10th of 1% of the customers eligible for a contract upgrade opt to sell us the upgrade.

While the exact numbers of subscribers that are under contract for each provider is not known, a report published on Jun. 30, 2013 discloses that Verizon Wireless had 100.1 million subscribers and AT&T had 78.4 million subscribers. AT&T reported in its quarterly financials that it added 551,000 contracts in the second quarter of 2013 and Verizon added 941,000 customers under contract in the same quarter. Based on the report on the published results on the earnings of AT&T and VERIZON in the second quarter of 2013, two-year contracts have helped the wireless service providers to clearly target the market for the major wireless service providers. The consumers will continue to opt for the two-year agreement because they are satisfied with their current wireless service provider.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the disclosure with modifications. However, all such modifications are deemed to be within the scope of the claims.

It is also to be understood that the following claims are intended to cover all of the generic and specific features of the embodiments described herein and all the statements of the scope of the embodiments, which as a matter of language might be said to fall there between.

What is claimed is:

1. A method for enhancing a contract based mobile phone consumer experience, the method comprising the steps of:
determining a consumer with expiring or expired contracts of the wireless communication service by a primary wireless service provider;
notifying the consumer of a due date for a contract renewal by the primary wireless service provider;
offering a new mobile phone at a subsidized price to an existing consumer by the primary wireless service provider, and wherein the primary wireless service provider offers the new mobile phone when the existing consumer signs an original contract;
providing an additional discount on the new mobile phone for the existing consumer in order to renew the contract at an expiry of contract;
providing an option for the existing consumer to retain an existing mobile phone that are already accustomed to the consumer and used by the consumer to continuously use an existing service of the primary wireless service provider without signing a renewal contract;
allowing the existing consumer to choose a third party service provider for a contract renewal;
allowing the third party service provider for purchasing the new mobile phone from the primary wireless service provider at the subsidized price; and
providing a monetary payment to the existing consumer from the third party service provider in exchange of the contract renewal, and wherein the existing consumer continues to use his/her mobile phone for an entire duration of the newly signed contract.

2. The method according to claim 1, wherein the primary wireless service provider offers the new mobile phone at the subsidized price to the existing consumer in exchange for an agreement to maintain a service with the primary wireless service provider for a limited period of time.

3. The method according to claim 1, wherein the third party service provider is allowed to resale the new mobile phone purchased at the subsidized price from the primary wireless service provider.

4. A method for enhancing profitability of a wireless service provider and retaining consumer in a contract based wireless communication service, the method comprising the steps of:
determining consumers of the wireless communication service with expired or expiring contracts by the wireless service provider;
notifying the consumers of a due date for a contract renewal by the wireless service provider;
offering an incentive to the consumers for a limited period in exchange of the contract renewal by the wireless service provider; and
retaining a consumer in an existing contract for using wireless communication service for a limited period.

5. The method according to claim 4, wherein the incentive offered to the consumers by the wireless service provider is a monetary payment.

6. The method according to claim 4, wherein the incentive offered to the consumers by the wireless service provider is a subsidized new mobile phone.

7. The method according to claim 4, wherein the wireless service provider posts the consumers contract details in a website, and wherein the wireless service provider allows the consumers to view the contracts and renewal the contracts by providing a login detail.

8. The method according to claim 4, wherein the wireless service provider provides an alert to the consumers when the contract is about to expire, and wherein the alert comprises an email notification, SMS, etc.

9. A computer implemented method run on a processor of the primary wireless service provider for enhancing contract based mobile phone consumer experience, the method comprises instructions to carry out the steps of:
determining a consumer with expiring or expired contracts of the wireless communication service by a primary wireless service provider;
notifying the consumer of a due date for a contract renewal by the primary wireless service provider;
offering a new mobile phone at a subsidized price to an existing consumer by the primary wireless service provider, and wherein the primary wireless service provider offers the new mobile phone when the existing consumer signs an original contract;
providing an additional discount on the new mobile phone for the existing consumer in order to renew the contract at an expiry of contract;
providing an option for the existing consumer to retain an existing mobile phone that are already accustomed to the consumer and used by the consumer to continuously use an existing service of the primary wireless service provider without signing a renewal contract;
allowing the existing consumer to choose a third party service provider for a contract renewal;
allowing the third party service provider for purchasing the new mobile phone from the primary wireless service provider at the subsidized price; and
providing a monetary payment to the existing consumer from the third party service provider in exchange of the contract renewal, and wherein the existing consumer continues to use his/her mobile phone for an entire duration of the newly signed contract.

10. The method according to claim 9, wherein the primary wireless service provider offers the new mobile phone at the subsidized price to the existing consumer in exchange for an agreement to maintain a service with the primary wireless service provider for a limited period of time.

11. The method according to claim 9, wherein the third party service provider is allowed to resale the new mobile phone purchased at the subsidized price from the primary wireless service provider.

12. A computer implemented method run on a processor of the primary wireless service provider for for enhancing profitability of a wireless service provider and retaining consumer in a contract based wireless communication service, the method comprising the steps of:
determining consumers of the wireless communication service with expired or expiring contracts by the wireless service provider;
notifying the consumers of a due date for a contract renewal by the wireless service provider;
offering an incentive to the consumers for a limited period in exchange of the contract renewal by the wireless service provider; and
retaining a consumer in an existing contract for using wireless communication service for a limited period.

13. The method according to claim 12, wherein the incentive offered to the consumers by the wireless service provider is a monetary payment.

14. The method according to claim 12, wherein the incentive offered to the consumers by the wireless service provider is a subsidized new mobile phone.

15. The method according to claim 12, wherein the wireless service provider posts the consumers contract details in a website, and wherein the wireless service provider allows the consumers to view the contracts and renewal the contracts by providing a login detail.

16. The method according to claim 12, wherein the wireless service provider provides an alert to the consumers when the contract is about to expire, and wherein the alert comprises an email notification, SMS, etc.
